(19) United States
(12) Patent Application Publication
(10) Pub. No.: US 2020/0327888 A1
(43) Pub. Date: Oct. 15, 2020

(54) DIALOGUE SYSTEM, ELECTRONIC APPARATUS AND METHOD FOR CONTROLLING THE DIALOGUE SYSTEM

(71) Applicants: Hyundai Motor Company, Seoul (KR); Kia Motors Corporation, Seoul (KR)

(72) Inventors: Jeong-Eom Lee, Yongin (KR); Youngmin Park, Gunpo (KR); Seona Kim, Seoul (KR)

(21) Appl. No.: 16/697,495

(22) Filed: Nov. 27, 2019

(30) Foreign Application Priority Data
Apr. 9, 2019 (KR) 10-2019-0041352

(51) Int. Cl. G10L 15/22; G10L 15/26; G10L 15/07

(52) U.S. Cl. CPC G10L 15/22; G10L 15/26; G10L 2015/227; G10L 2015/228; G10L 15/07

(57) ABSTRACT

A dialogue system is provided and includes a storage that is configured to store relationship information and an input processor that is configured to collect context information associated with a content of a message in response to receiving an utterance including a receiver and the content of the message input from the user. A dialogue manager is configured to determine a relationship between the user and the receiver based on the relationship information and generate a meaning representation for converting the context information into a sentence based on the relationship between the user and the receiver. A result processor is then configured to generate a message transmitted to the receiver based on the relationship between the user and the receiver, the content of the message and the meaning representation.

### CROSS-REFERENCE TO RELATED APPLICATION(S)

This application is based on and claims priority under 35 U.S.C. § 119 to Korean Patent Application No. 10-2019-0041352, filed on Apr. 9, 2019, the disclosure of which is incorporated by reference herein in its entirety.

### BACKGROUND

### 1. Field of the Disclosure

The present disclosure relate to a dialogue system, and an electronic apparatus which have dialogues with users and a method for controlling the dialogue system.

### 2. Description of Related Art

A dialogue system recognizes user's speech and provides services corresponding to the recognized speech. One of the services provided by the dialogue system may be message transmission. When a user requests to send a message using voice, the dialogue system sends the message to a receiver based on a content of the user. speech. if, for example, a situation or a relationship between the user and the receiver is not considered when sending the message, it could be possible that an inappropriate message is sent or an intention of the user is not fully reflected in the message.

### SUMMARY

The present disclosure provides a dialogue system, and an electronic apparatus for sending messages to which user's intentions are fully reflective of an emotional relationship between the user and the receiver, current context information, etc. as well as a social relationship between the user and the receiver, when the user requests message transmission, and a method for controlling the dialogue system.

In accordance with one aspect of the present disclosure, a dialogue system may include a storage configured to store relationship information; an input processor configured to collect context information associated with a content of a message in response to receiving an utterance including a receiver and the content of the message input from the user; a dialogue manager configured to determine a relationship between the user and the receiver based on the relationship information and generate a meaning representation for converting the context information into a sentence based on the relationship between the user and the receiver; and a result processor configured to generate a message transmitted to the receiver based on at least one or more of: the relationship between the user and the receiver, the content of the message and the meaning representation.

The relationship between the user and the receiver may include a social relationship and an emotional relationship. The storage may be configured to store a message characteristic in which a characteristic of the message transmitted by the user is matched with: the emotional relationship between the user and a receiver, and a context. The dialogue manager may be configured to generate the meaning representation based on the message characteristic. The characteristic of the message may include at least one of a speech act and a speech tone. The message characteristic may be stored in a database.

The dialogue manager may be configured to obtain an emotional state of the user, and generate the meaning representation based on the relationship between the user and the receiver and the emotional state of the user. The storage may be configured to store the message characteristic in which a characteristic of the message transmitted by the user is matched with: the emotional relationship between the user and a receiver, the emotional state of the user, and a context, and the dialogue manager is configured to generate the meaning representation based on the message characteristic. The relationship information may include at least one of a message history of the user, a call history of the user, a contact of the user and a writing history in a social media of the user. The message characteristic may be stored in a database.

In accordance with another aspect of the present disclosure, a method for controlling a dialogue system may include receiving an utterance including a receiver and a content of a message from a user; collecting context information related to the content of the message; determining a relationship between the user and the receiver; generating a meaning representation for converting the context information into a sentence based on the relationship between the user and the receiver; and generating a message transmitted to the receiver based on the content of the message and the meaning representation.

The determining of a relationship between the user and the receiver may include determining a social relationship and an emotional relationship based on relationship information including at least one of a message history of the user, a call history of the user, a contact of the user and a writing history in a social media of the user. The method may further include matching a characteristic of a message, which the user sent, with the emotional relationship between the user and a receiver, and a context, and storing the characteristic of the message matched with the emotional relationship and the context.

The generating of a meaning representation may include searching for the message characteristic matched with the determined emotional relationship and a current context, and generating the meaning representation using the searched message characteristic. The method may further include obtaining an emotional state of the user. The generating of the meaning representation may include generating the meaning representation for converting the context information into the sentence based on the relationship between the user and the receiver and the emotional state of the user.

The method may further include matching a characteristic of a message, which the user sent, with the emotional relationship between the user and a receiver, the emotional state of the user and a context, and storing the characteristic of the message matched with the emotional relationship and the context. The generating of a meaning representation may include searching for the characteristic of the message matched with the determined emotional relationship, the emotional state of the user and a current context, and generating the meaning representation using the searched characteristic of the message.

In accordance with another aspect of the present disclosure, an electronic apparatus may include receiving an utterance including a receiver and a content of a message from a user; collecting context information related to the content of the message; and determining a relationship between the user and the receiver. Also, the electronic apparatus may include generating a meaning representation for converting the context information into a sentence based on the relationship between the user and the receiver; and generating a message transmitted to the receiver based on the content of the message and the meaning representation.

### BRIEF DESCRIPTION OF THE DRAWINGS

These and/or other aspects of the present disclosure will become apparent and more readily appreciated from the following detailed description of embodiments, taken in conjunction with the accompanying drawings of which:

FIG. 1 is a control block diagram illustrating a dialogue system in accordance with an exemplary embodiment of the disclosure;

FIG. 2 is a control block diagram illustrating components of an input processor of the dialogue system in accordance with an exemplary embodiment of the disclosure;

FIG. 3 is a control block diagram illustrating components of a dialogue manager of the dialogue system in accordance with an exemplary embodiment of the disclosure;

FIGS. 4 and 5 are views illustrating an example of features of messages which are stored in a storage of the dialogue system in accordance with an exemplary embodiment of the disclosure;

FIG. 6 is a control block diagram illustrating components of a result processor of the dialogue system in accordance with an exemplary embodiment of the disclosure;

FIG. 7 is a view illustrating an example of dialogues which the dialogue system and the user have in accordance with an exemplary embodiment of the disclosure;

FIG. 8 is a view illustrating an example of meaning representation which is generated by a meaning representation generator in accordance with input such as a current location, traffic information, a speech act, a speech tone and an estimated arrival time; and

FIG. 9 is a flow chart illustrating method for controlling the dialogue system in accordance with an exemplary embodiment of the disclosure.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Exemplary embodiments disclosed in the description and configurations shown in the drawings are preferred examples of the disclosed invention. There may be various modifications that may replace the exemplary embodiments and drawings of the present description at the time of filing of the present application. Also, the terminologies used herein are for the purpose of describing particular embodiments only and are not used to restrict the disclosed invention. Singular expressions include plural expressions unless there is a particular description contrary thereto. As used herein, the terms “comprise”, “include” or “have” are intended to designate that the features, numbers, steps, operations, components, elements, or combinations thereof described in the description exist, not to exclude any other feature or number, step, operation, component, part, or combination thereof in advance.

In addition, terms such as “˜part”, “˜unit”, “˜block”, “˜member”, “˜module” may refer to a unit for processing at least one function or operation. For example, the terms may refer to at least one hardware such as a field-programmable gate array (FPGA), application specific integrated circuit (ASIC), etc., at least one program stored in a memory, or at least one process which is processed by a processor.

Although at least one exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The symbols attached to the steps are used to identify the steps. These symbols do not indicate the order between the steps. Each step is performed in a different order from the stated order unless the context clearly indicates a specific order.

Meanwhile, the disclosed exemplary embodiments may be implemented in the form of a recording medium for storing instructions executable by a computer. The instructions may be stored in the form of program code and, when executed by a processor, may generate a program module to perform the operations of the disclosed exemplary embodiments. The recording medium may be implemented as a non-transitory computer-readable recording medium. Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, the present disclosure will be described in detail with reference to the accompanying drawings.

A dialogue system according to an exemplary embodiment is an apparatus configured to recognize a user's intention using the user's speech (i.e., utterance or verbal communication of words) and non-speech input and provide a service appropriate for the user's intention. The dialogue system may also be configured to provide a service that the user needs by determining the service by itself even when there is no input from the user.

One of the services provided by the dialogue system may be message transmission. The message transmission may include both text message transmission and voice message transmission, but in the exemplary embodiments described below, examples with regard to the text message transmission will be described in detail.

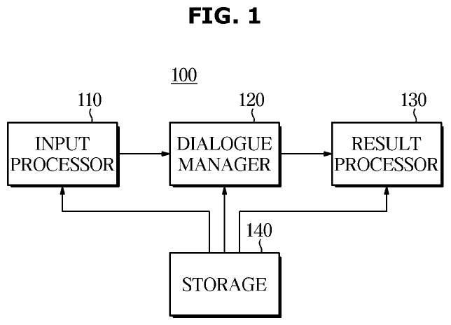

FIG. 1 is a control block diagram illustrating a dialogue system in accordance with an exemplary embodiment of the disclosure. Referring to FIG. 1, according to an exemplary embodiment, a dialogue system 100 may include a storage 140 configured to store relationship information including at least one of a message history, a call history, a contact and writing history in social media of the user and an input processor 110 configured to collect context information associated with a content of a message in response to receiving an utterance including a receiver and the content of the message input from the user. A dialogue manager 120 may be configured to determine a relationship between the user and the receiver based on the relationship information and generate a meaning representation for converting the context information into a sentence based on the relationship between the user and the receiver and a result processor 130 may be configured to generate a message transmitted to the receiver based on at least one or more of: the relationship between the user and the receiver, the content of the message and the meaning representation.

The storage 140 may be configured to include at least one of non-volatile memories including a flash memory, Read Only Memory (ROM), Erasable Programmable Read Only Memory (EPROM), Electrically Erasable Programmable Read Only Memory (EEPROM), and etc. In addition, the storage 140 may be configured to include at least one of volatile memories including Random Access Memory (RAM), Static Random Access Memory (S-RAM), Dynamic Random Access Memory (D-RAM), etc.

The input processor 110, the dialogue manager 120 and the result processor 130 may be configured to include at least one memory configured to store programs including instructions for performing the above-described operations and operations to be described later and various types of data related to the operations and at least one processor configured to execute the stored programs. Accordingly, any electronic apparatuses, which include at least one memory configured to store programs including instructions for performing the above-described operations and operations to be described later and at least one processor configured to execute the stored programs, may be included in the scope of the dialogue system 100 in accordance with an exemplary embodiment.

Additionally, the input processor 110, the dialogue manager 120 and the result processor 130 may be configured to share the memory or the processor. Otherwise, the input processor 110, the dialogue manager 120 and the result processor 130 may be configured to use a separate memory and a separate processor, respectively. When the dialogue system 100 includes a plurality of memories and a plurality of processors, they may be integrated on one chip, or may be separated from each other physically.

In addition, the input processor 110, the dialogue manager 120, the result processor 130, and the storage 140 may be provided in a server of a service provider, or may be provided in a user's terminal for providing dialogue service, such as a vehicle, a home appliance, a smart phone, an artificial intelligence speaker, etc. In the former case, when a user's speech is input to a microphone provided in the user's terminal, the user's terminal converts the user's speech into a voice signal and transmits the voice signal to the service provider's server.

Furthermore, some operations of the input processor 110, the dialogue manager 120, and the result processor 130 may be performed at the user's terminal, and some of the remaining operations may be performed at the service provider's server based on the capacity of the memories and the processing capability of the processors of the user's terminal. In the following exemplary embodiments, a case in which the user is a driver of the vehicle and the user's terminal is the vehicle or a mobile device such as the smart phone connected to the vehicle will he described as an example.

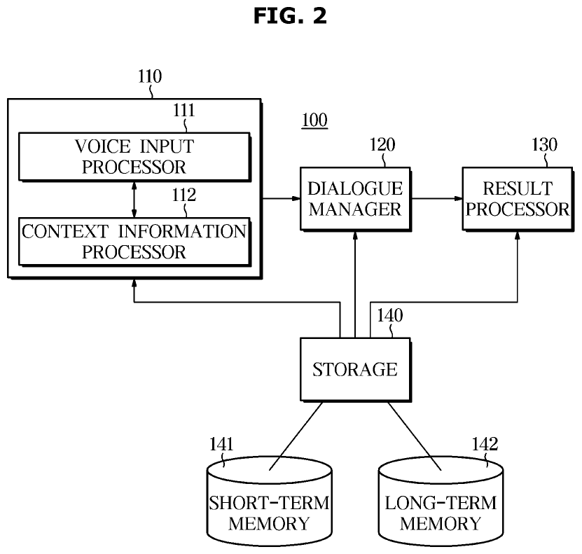

FIG. 2 is a control block diagram illustrating components of the input processor of the dialogue system in accordance with an exemplary embodiment. Referring to FIG. 2, the input processor 110 may be configured to include a voice input processor 111 configured to process a voice input and a context information processor 112 configured to process context information. The user's voice input, which is input via the microphone of the user's terminal, may be transmitted to the voice input processor 111, and the context information, which is obtained by a sensor of the user's terminal or by communication v n external server, may be transmitted to the context information processor 112.

The voice input processor 111 may be configured to include a speech recognizer configured to recognize user's speech and output text utterance corresponding to the user's speech, and a natural language understanding processer configured to determine user's intentions included in the text of the utterance by applying natural language understanding technology to the utterance. The speech recognizer may be configured to include a speech recognition engine and the speech recognition engine may be configured to recognize the user's speech by applying a speech recognition algorithm and generate a result of the recognition. Text of the utterance which is the result of the recognition may be input to the natural language understanding processor. The natural language understanding processor may be configured to determine the user's intention included in the utterance by applying natural language understanding technology.

First, the natural language understanding processor may he configured to perform morphological analysis on the utterance to transform an input string into a morpheme string. Additionally, the natural language understanding processor may be configured to recognize an entity name from the utterance. The entity name may be a proper noun (e.g., people names, location names, organization names, time, date, or currency) and the entity name recognition may be configured to identify the entity name in a sentence and determine the type of entity name identified. The natural language understanding processor may be configured to extract important keywords from the sentence using the entity name recognition and recognize the meaning of the sentence.

The natural language understanding processor may be configured to extract a domain from the utterance. The domain may be used to identify a subject of the utterance. The domains indicating a variety of subjects, e.g., message, navigation, schedule, weather, traffic, vehicle control, may be stored. as a database in the storage 140.

In addition, the natural language understanding processor may be configured to analyze a speech act contained in the utterance. The speech act analysis may include identifying the intention of the utterance, e.g., whether the user asks a question, whether the user makes a request, whether the user responds or whether the user simply expresses an emotion.

Further, the natural language understanding processor may be configured to identify the intention of the utterance based on the information, e.g., domain, entity name, and speech act and extract an action corresponding to the utterance. The action may be defined by an object and an operator. The natural language understanding processor may be configured to extract factors related to the action execution. The factors related to the action execution may be effective factors which are directly required for the action execution, or ineffective factors which are used to extract the effective factors.

For example, when the utterance which the speech recognizer outputs is “send a message to Gildong”, the natural language understanding processor may be configured to determine “message” as a domain corresponding to the utterance and “send_message” as an action corresponding to the utterance. A speech act may be “request”. [Gildong] which is the entity name is [factor 1: receiver] related to the action execution. However, [factor 2: specific content of the message] is further required for the actual message transmission. In particular, the dialogue system 100 may be configured to output a system utterance, for example, “please tell me a content of the message which you want to send”, to obtain the specific content of the message from the user.

In accordance with an exemplary embodiment, the dialogue system 100 may be configured to provide a service sufficiently reflecting the intention of the user by transmitting a message based on the relationship between the user and the receiver and context information, instead of merely transmitting the content of the message requested by the user as it is. Accordingly, the context information processor 112 may be configured to collect context information related to the content of the user's spoken message. For example, the context information related to the content of the user's spoken message may include traffic information, current location, arrival time, schedule, condition of the vehicle, etc.

The storage 140 may be configured to store data separately in a short-term memory 141 and a long-term memory 142 based on importance or durability of the date to be stored and the intention of the user. The short-term memory 141 may he configured to store various sensor values measured within a reference time period from a current time, contents of dialogues conducted within a reference time period from a current time point, information provided from an external server within a reference time period from a current time point, a schedule registered by the user, etc. The long term memory 142 may be configured to store a contact, a user's preference for a specific subject, etc. Additionally, newly acquired information by processing data stored in the short term memory 141 may be stored in the long term memory 142.

Relationship information indicating a relationship between the user and another person, such as the message history of the user, the call history, and the writing history in the social media, may be stored in the short term memory 141 or may be stored in the long term memory 142. For example, the message history, the call history, and the writing history in the social media accumulated within a reference time period from a current time point may be stored in the short-term memory 141, and when a reference time period elapses, the stored history may be automatically deleted. Alternatively, the message history, call history, and the writing history in the social media may he stored in the long term memory 142 regardless of the time point.

For example, when the content of the message determined by the voice input processor 11 indicates that the user will be late for an appointment, the context information processor 112 may be configured to collect information such as a current location, a traffic condition, an arrival time, a vehicle state, etc. If the information is already stored in the short-term memory 141, the information may be obtained from the short-term memory 141, and if the information is not yet stored in the short-term memory 141, the information may be obtained by request from the external server or vehicle sensor.

As another example, when the message content determined by the voice input processor 111 is content for setting a new appointment, the context information processor 112 may be configured to collect information including a user's schedule, home address, a receiver's home address, map information, points of interest (POIs) near a user's preferred location, etc. If the information is already stored in the short-term memory 141, the information may be obtained from the short-term memory 141, and if the information is not yet stored in the short-term memory 141, the information may be obtained by request from the external server.

The input processor 110 may be configured to transmit the context information associated with the content of the message and the result of the natural language understanding such as domain, action, factors, etc., to the dialogue manager 120.

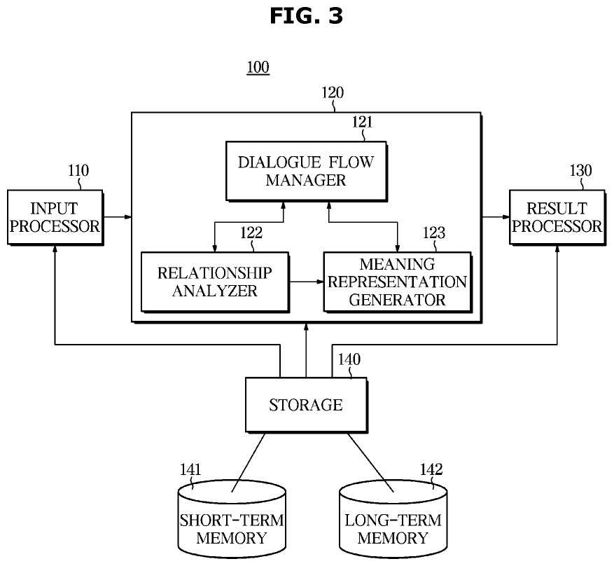

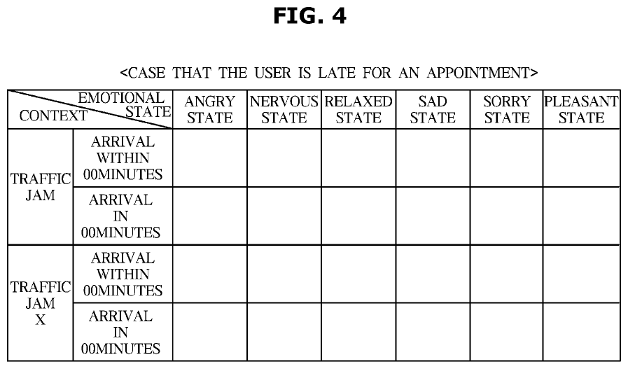

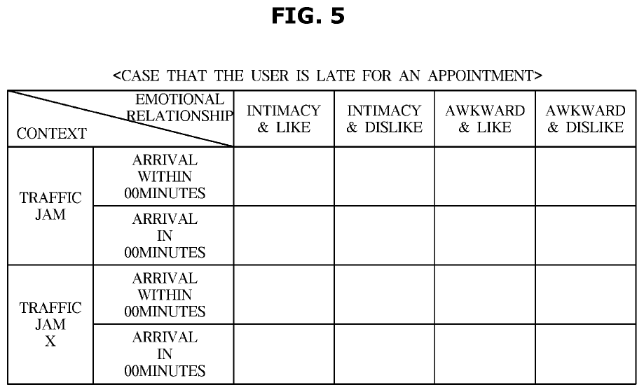

FIG. 3 is a control block diagram illustrating components of the dialogue manager of the dialogue system in accordance with an exemplary embodiment of the disclosure and FIGS. 4 and 5 are views illustrating an example of features of messages which are stored in the storage of the dialogue system in accordance with an exemplary embodiment of the disclosure.

Referring to FIG. 3, the dialogue manager 120 may be configured to include a dialogue flow manager 121 configured to manage a flow of a dialogue by generating, deleting, and updating a dialogue or an action, a relationship analyzer 122 configured to analyze a relationship between the user and the receiver and a meaning representation generator 123 configured to generate a meaning representation for converting the context information into a sentence. The dialogue flow manager 121 may be configured to determine whether a dialogue task or an action task corresponding to the action transmitted from the input processor 110 has already been generated. When the dialogue task or the action task corresponding to the action transmitted from the input processor 110 has already been generated, the dialogue or the action may be continued with reference to the dialogue or the action performed in the already generated task. Alternatively, when the dialogue task or the action task corresponding to the action transmitted from the input processor 110 has not been generated, the dialogue flow manager 121 may be configured to newly generate the dialogue task or the action task.

The relationship analyzer 122. may be configured to analyze the relationship between the user and the receiver based on the relationship information including at least one of the message history, the call history, the contact, and the writing history in the social media of the user stored in the storage 140. The relationship between the user and the receiver may include a social relationship and an emotional relationship.

The social relationship may refer to a relationship defined by occupation, kinship, schooling, etc. such as friends, superiors, senior colleagues, junior colleagues, school seniors, school juniors, school parents, parents, grandparents, children, and relatives. The emotional relationship may refer to a relationship defined by likeability to a counterpart or intimacy with the counterpart. For example, when the receiver is a “team leader”, the social relationship may be “superiors” and the emotional relationship may be “like & intimacy”, “dislike & intimacy”, “dislike & awkward” or “like & awkward”.

The social relationship may be determined by a title that refers to the receiver, or may be determined based on the contact. When the social relationship is unable to be determined. by the title or the contact, the social relationship may be determined based on the relationship information such as the message history, the call history, the writing history in the social media history, and the like.

The emotional relationships may also be determined based on the relationship information such as the contact, the message history, the call history, the writing history in the social media, and the like. For example, when the receiver is “team leader” and her phone number is stored matching with “Witch leader Kim”, the emotional relationship to the receiver may be “dislike”. In addition, it could be determined whether the relationship between the user and the receiver is intimate or awkward, by analyzing the message history or the call history between the user and the receiver.

As another example, when the receiver is “Hong Gildong”, and “Hong Gildong” is stored in a friend group of the contact, the receiver may be determined as the user's “friend”. Additionally, the system, the apparatus, the processor or a component thereof may he configured to determine whether the relationship between the user and the receiver is intimate or awkward and like or dislike by analyzing the message history or call history between the user and the receiver. In addition, by analyzing the dialogue history between the user and the receiver, and the dialogue history with other people, it may be determined whether the user and Hong Gildong are intimate or awkward, and whether the user's feelings about Hong Gildong are like or dislike.

The meaning representation generator 123 may be configured to generate the meaning representation for converting the context information into a sentence. The meaning representation in dialogue processing may be a result of the natural language understanding or may be an input of natural language generation. For example, the input processor 110 may be configured to generate the meaning representation which represents the user's intention by analyzing the user's utterance, and the dialogue manager 120 may be configured to generate the meaning representation corresponding to a next system utterance based on the dialogue flow and the context. The result processor 130 may be configured to generate the sentence to be spoken by the system based on the meaning representation output from the dialogue manager 120.

The storage 140 may be configured to match and store characteristics of messages, which the user sent and received, for respective context. This is referred to as a message characteristic. The message characteristic may be stored in a database. The characteristic of the message may include at least one of a dialogue act and a tone. The tone may include whether to use a formal format or an informal manner, whether to use emojis, whether to use a character or phrase denoting formal or informal speech, whether to use formal language such as honorifics, a Korean character such as “∘”, which is a circle symbol, which in the Korean language may be used to denote a consonant in a vowel-initial syllable, to speak in an intimate manner, whether to use an onomatopoeia, and the like.

For example, based on the user's dialogue history, whether the user uses emojis or onomatopoeic words when the user is late for an appointment and the user is stuck in traffic may be stored. The context refers to the user sending or receiving a message. The context may be determined by the content of the message or may be determined by the context information associated with the content of the message. Notably, the present disclosure is not limited to the above described tones.

In addition, as shown in FIG. 4, the characteristic of the message may be stored separately based on emotional states of the user as well as the context. For example, even in the same context in which the user is late for the appointment and there is a traffic jam, at least one different characteristic of the message may be stored based on whether the user's emotional state is angry state, nervous state, relaxed state, sad state, sorry state, or pleasant state.

As one example, in the case that a context indicates that there is a traffic jam and the user is expected to arrive in 00 minutes and an emotional state of the user indicates that he/she feels sorry, a characteristic of the message including using a formal format, not using emojis, using the Korean character such as “∘”, and using the onomatopoeia may bematched with the context and the emotional state of the user.

The emotional state of the user may be determined using an output value of a sensor measuring a bio signal of the user, or may be determined by analyzing voice tone, tone of speech, content, etc. included in the user's utterance. There is no restriction on how to determine the emotional state of the user.

The meaning representation generator 123 may he configured to search for the characteristic of the message matched with the current context and the current emotional state of the user, and generate the meaning representation for converting the context information into the sentence using the searched characteristic of the message. In addition, as shown in FIG. 5, the characteristic of the message may be stored separately based on the context and the emotional relationship between the user and the receiver. For example, in the context in which the user is late for an appointment and there is a traffic jam, the tone or whether to use emojis may be stored differently based on the intimacy or likeability between the user and the receiver.

As one example, in the case that a context indicates that there is a traffic jam and the user is expected to arrive in 00 minutes and an emotional state of the user indicates that he/she feels sorry, a characteristic of the message including using a formal format, not using emojis, using the Korean character such as “∘”, and not using the onomatopoeia may be matched with the context and the emotional relationship between the user and the receiver.

The meaning representation generator 123 may be configured to search for the characteristic of the message matched with the current context and the emotional relationship between the user and the receiver, and generate the meaning representation for converting the context information into the sentence using the searched characteristic of the message. Furthermore, it may also be possible that the characteristics of the messages are stored after matching with the context, the emotional relationship between the user and the receiver, and the emotional state of the user, respectively.

The characteristic of the message may he reflected in the sentence indicating the context information and in the content of the message spoken by the user. For example, when the user utters, “Send a message that I will be a little late”, when generating a sentence including a meaning that the user will be late, the characteristics of the messages described above may be reflected. In addition, even when the user utters “I will be a little late” in response to a system utterance asking for the contents of the message, the dialogue system 100 may be configured to transmit a modified message reflecting the characteristic of the message described above instead of sending “I will be a little late” as it is literally.

Meanwhile, the output of the relationship analyzer 122 may also be considered as a meaning representation, thus a meaning representation indicating the social relationship and the emotional relationship between the user and the receiver, and a meaning representation, which is an output of the meaning representation generator 123, indicating the context information associated with the content of the message and the characteristic of the message may be transmitted to the result processor 130.

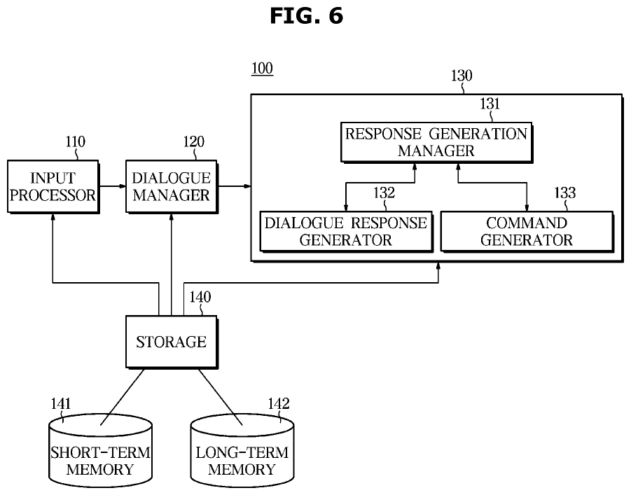

FIG. 6 is a control block diagram illustrating components of the result processor of the dialogue system in accordance with an exemplary embodiment of the disclosure. Referring to FIG. 6, the result processor 130 may be configured to include a response generation manager 131 configured to manage the generation of a response required to perform the action input from the dialogue manager 120, a dialogue response generator 132 configured to generate a text response, an image response or an audio response based on a request of the response generation manager 131, and a command generator 133 configured to generate a command for performing the action based on a request of the response generation manager 131.

When information related to the action, for example, [action: send (operator)_message(object)], [action factor 1: a receiver], [action factor 2: content of message], and the meaning representation for converting the context, information into the sentence are transmitted from the dialogue manager 120, the dialogue response generator 132 may be configured to generate a message corresponding to the transmitted information and the command generator 133 may be configured to generate a command for transmitting the message.

When the dialogue response generator 132 generates the message, the dialogue response generator 132 may refer to a response template or the dialogue response generator 132 may generate the message based on a rule stored in the storage 140. In addition, the dialogue response generator 132 may be configured to generate a dialogue response to receive confirmation from the user before transmitting the message. When the dialogue response generator 132 generates the dialogue response, the dialogue response generator 132 may refer to the response template stored in the storage 140 or the dialogue response may be based on the rule.

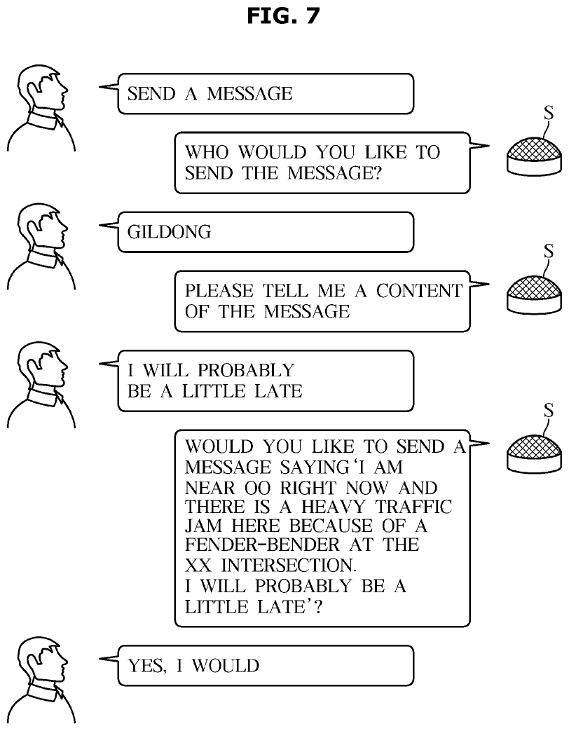

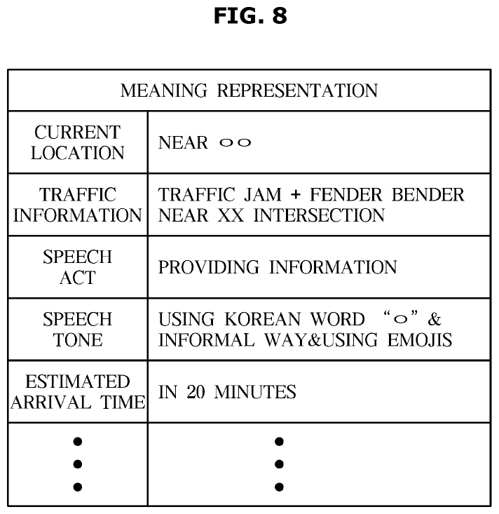

FIG. 7 is a view illustrating an example of dialogues which the dialogue system and the user have in accordance with an exemplary embodiment, and FIG. 8 is a view illustrating an example of meaning representation which is generated by the meaning representation generator.

Referring to an example of FIG. 7, when the user utters “send message”, the voice input processor 111 determines the utterance as [domain: message] and [action: send_message] by the speech recognition engine and natural language understanding processor. However, since the receiver and the content of the message, which are necessary factors for performing the message transmission action, are missing, the dialogue response generator 132 may be configured to output the system utterance, for example, “Who would you like to send the message?” (or “To whom would you like to send the message?” or “Who would you like to send the message to?” and the like) to confirm the receiver in response to user utterance. The system utterance may be transmitted to a suitable output device, such as speaker S.

When the user utters the name of the receiver, e.g., “Gildong”, the relationship analyzer 122 may be configured to determine the social relationship and the emotional relationship between the user and Gildong based on the relationship information stored in the storage 140.

The dialogue response generator 132 may be configured to output the system utterance “please tell me a content of the message” to obtain the content of the message. When the user utters the content of the message “I will probably be a little late”, the context information processor 112 may be configured to collect the current location, the traffic condition, the arrival time, and the like, which is context information associated with the content of the message. When the relationship analyzer 122 determines “friend” as the social relationship between the user and Gildong and “intimacy & like” as the emotional relationship between the user and Gildong, and “using emojis & using the Korean character ”∘“ & informal way of speaking” (“informal way” may be “informal manner” and the like) is stored as the characteristic of the message corresponding to the current context and the emotional relationship, the meaning representation generator 123 may be configured to generate the meaning representation as shown in FIG. 8.

Referring to FIG. 8, the meaning representation generated by the meaning representation generator 123 may be [current location: near ∘ ∘], [traffic information: congestion+fender-bender near xx intersection], [speech act: providing information], [estimated arrival time: in 20 minutes], [tone of speech: using the Korean character “∘” & informal way of speaking & using emojis]. Please note, in FIG. 8, “∘ ∘” represents a current location, which is different from the Korean character “∘” described above, which may be used to denote informal speech.

The dialogue manager 120 may be configured to transmit a meaning representation including [action: send_message], [receiver: Gildong], [content of the message spoken by the user: I will probably be a little late], [social relationship: friend], [emotional relationship: intimacy & like], etc. and a meaning representation shown in FIG. 8 to the result processor 130.

The dialogue response generator 131 of the result processor 130 may be configured to generate a message corresponding to the transmitted meaning representation based on the response template or the rule. For example, the generated message may be “I am near ∘ ∘ right now and there is a heavy traffic jam here because of a fender-bender at the xx intersection. I will probably be a little late”.

In addition, the dialogue response generator 132 may be configured to output “Would you like to send a message saying ‘I am near ∘ ∘ right now and there is a heavy traffic jam here because of a fender-bender at the xx intersection. I will probably be a little late’?” as the system utterance to confirm whether to send the generated message. When the user utters “Yes, I would” to confirm to transmit the generated message, the command generator 133 may be configured to generate the command to send the message “I am near ∘ ∘ right now and there is a heavy traffic jam here because of a fender-bender at the xx intersection. I will probably be a little late”, and send the message based on the generated command.

Hereinafter, an exemplary embodiment of the method for controlling the dialogue system will be described below. When performing the method for controlling the dialogue system according to an exemplary embodiment, the dialogue system 100 according to the above-described exemplary embodiment may be used. Therefore, the description regarding the dialogue system 100 described above with reference to FIGS. 1 to 8 may be applied to the method for controlling the dialogue system even if not mentioned otherwise. The method described hereinbelow may be executed by a controller.

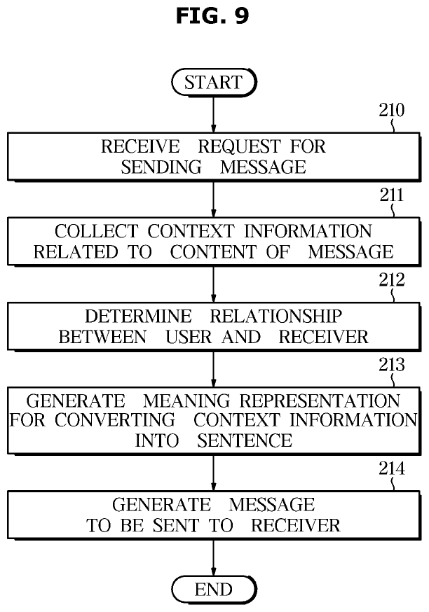

FIG. 9 is a flow chart illustrating method for controlling the dialogue system in accordance with an exemplary embodiment of the disclosure. Referring to FIG. 9, a method for controlling the dialogue system according to an exemplary embodiment may include receiving a request for sending a message from a user (210), collecting context information related to the content of the message (211), determining a relationship between the user and the receiver (212), generating a meaning representation for converting the context information into a sentence (213), and generating a message to be sent to the receiver (214).

The user may input an utterance for a request for sending a message to a microphone provided in a user's terminal. The utterance for requesting a message to be sent may include the receiver and the content of the message. The receiver and the content of the message may be uttered at once or may be uttered step by step. The contextual information associated with the content of the message may include information such as current location, traffic information, arrival time, condition of the vehicle, user's schedule, receiver's home address, map information, POI, and the like. When such information is already obtained and stored in the short-term memory 141 or the long-term memory 142, the necessary information may be accessed from the short-term memory 141 or the long-term memory 142. Alternatively, when such information is not obtained yet, the dialogue system 100 may be configured to request the necessary information to external servers, vehicle sensors, etc.

The relationship between the user and the receiver may include social relationship and emotional relationship. The social relationship may be determined by a title that refers to the receiver, or may be determined based on a contact. When the social relationship is unable to be determined by a title or contact, the social relationship may be determined based on relationship information such as a message history, a call history, a writing history in social media, and the like. The emotional relationship may also be determined based on the relationship information such as a contact, the message history, the call history, the writing history in social media, and the like.

Meanwhile, according to the method for controlling the dialogue system according to an exemplary embodiment, the characteristics of the messages which the user sent or received may be stored for each context in a database. The characteristics of the messages may be distinguished in the context and in the emotional relationship between the user and the receiver. Therefore, the method for controlling the dialogue system according to an exemplary embodiment may further include matching and storing characteristics of messages sent by the user for each emotional relationship between the user and receivers, and for each context.

The generating of a meaning representation (213) may include searching for the characteristic of the message matched with the emotional relationship between the user and the receiver, and the current context, and generating the meaning representation for converting the context information into the sentence using the searched characteristic of the message. In addition, when generating the meaning representation, it may also be possible to reflect an emotional state of the user. Accordingly, the characteristics of the messages may be matched and stored for each emotional relationship between the user and the receiver, each emotional state of the user, and each context.

When the current emotional state of the user is obtained, the characteristic of the message matched with the emotional relationship between the user the receiver determined in the step 212, the current context and the current emotional state of the user may be searched in the message characteristic and the meaning representation may be generated using the searched the characteristic of the message. The message characteristic may be stored in a database.

According to the above-described dialogue system and the method for controlling the same, an advantage is achieved, that is, for example, when the user requests the dialogue system 100 to send a message, the content of the message uttered by the user as well as the context information associated with the content of the message may be transmitted together. Additionally, it may be possible to transmit a natural message that fully reflects the intention of the user based on the tone determined based on the social relationship and the emotional relationship between the user and the receiver.

Although a few exemplary embodiments of the disclosure have been shown and described, it would be appreciated by those skilled in the art that changes may be made in these exemplary embodiments without departing from the principles and spirit of the disclosure, the scope of which is defined in the claims and their equivalents.

The foregoing description has been directed to exemplary embodiments of the present disclosure. It will be apparent, however, that other variations and modifications may be made to the described exemplary embodiments, with the attainment of some or all of their advantages. Accordingly, this description is to be taken only by way of example and not to otherwise limit the scope of the exemplary embodiments herein. Therefore, it is the object of the appended claims to cover all such variations and modifications as come within the true spirit and scope of the exemplary embodiments herein.

What is claimed is:

1. A dialogue system, comprising:
a storage configured to store relationship information;
an input processor configured to collect context information associated with a content of a message in response to receiving an utterance including a receiver and the content of the message input from the user;
a dialogue manager configured to determine a relationship between the user and the receiver based on the relationship information and generate a meaning representation for converting the context information into a sentence based on the relationship between the user and the receiver; and
a result processor configured to generate a message transmitted to the receiver based on:
the relationship between the user and the receiver,
the content of the message, and
the meaning representation.

2. The dialogue system according to claim 1, wherein the relationship between the user and the receiver includes a social relationship and an emotional relationship.

3. The dialogue system according to claim 2, wherein the storage is configured to store a message characteristic of the message transmitted by the user, and
wherein the message characteristic is matched with:
the emotional relationship between the user and the receiver, and
a context.

4. The dialogue system according to claim 3, wherein the dialogue manager is configured to generate the meaning representation based on the message characteristic.

5. The dialogue system according to claim 3, wherein the characteristic of the message includes at least one of a speech act and a speech tone.

6. The dialogue system according to claim 1, wherein the dialogue manager is configured to:
determine an emotional state of the user, and
generate the meaning representation based on:
the relationship between the user and the receiver, and
the emotional state of the user.

7. The dialogue system according to claim 6,
wherein the storage is configured to store a message characteristic of the message transmitted by the user,
wherein the message characteristic is matched with:
the emotional relationship between the user and the receiver,
the emotional state of the user, and
a context, and
wherein the dialogue manager is configured to generate the meaning representation based on the message characteristic.

8. The dialogue system according to claim 1, wherein the relationship information includes at least one of a message history of the user, a call history of the user, a contact of the user, and a writing history in a social media of the user.

9. A method for controlling a dialogue system comprising:
receiving, by a controller, an utterance including a receiver and a content of a message from a user;
collecting, by the controller, context information related to the content of the message;
determining, by the controller, a relationship between the user and the receiver;
generating, by the controller, a meaning representation for converting the context information into a sentence based on the relationship between the user and the receiver; and
generating, by the controller, a message transmitted to the receiver based on the content of the message and the meaning representation.

10. The method according to claim 9, wherein the determining of the relationship between the user and the receiver includes:
determining, by the controller, a social relationship between the user and the receiver and an emotional relationship between the user and the receiver based on relationship information including at least one of a message history of the user, a call history of the user, a contact of the user and a writing history in a social media of the user.

11. The method according to claim 10, further comprising:
matching, by the controller, a characteristic of a message transmitted by the user with the emotional relationship between the user and the receiver, and a context, and
storing, by the controller, the characteristic of the message matched with the emotional relationship and the context.

12. The method according to claim 11, wherein the generating of the meaning representation includes:
searching, by the controller, for the message characteristic matched with the determined emotional relationship and a current context; and
generating, by the controller, the meaning representation using the searched message characteristic.

13. The method according to claim 9, further comprising:
determining, by the controller, an emotional state of the user.

14. The method according to claim 13, wherein the generating of the meaning representation includes:
generating, by the controller, the meaning representation for converting the context information into the sentence based on:
the relationship between the user and the receiver, and
the emotional state of the user.

15. The method according to claim 14, further comprising:
matching, by the controller, a characteristic of the message transmitted by the user with:
the emotional relationship between the user and a receiver,
the emotional state of the user, and
a context, and
storing the characteristic of the message matched with the emotional relationship, the emotional state of the user, and the context.

16. The method according to claim 15, wherein the generating of the meaning representation includes:
searching, by the controller, for the characteristic of the message matched with:
the determined emotional relationship,
the emotional state of the user, and
a current context, and
generating the meaning representation using the searched characteristic of the message.

17. An electronic apparatus comprising:
a memory configured to store program instructions; and
a processor configured to execute the program instructions, the program instructions when executed configured to:
receive an utterance including a receiver and a content of a message from a user;
collect context information related to the content of the message;
determine a relationship between the user and the receiver;
generate a meaning representation for converting the context information into a sentence based on the relationship between the user and the receiver; and
generate a message transmitted to the receiver based on the content of the message and the meaning representation.
